(19) United States
(12) Patent Application Publication
(10) Pub. No.: US 2026/0106089 A1
(43) Pub. Date: Apr. 16, 2026

(54) AMPLIFICATION OF INTERFACIAL CAPACITANCE IN IONIC LIQUID ELECTROLYTES

(71) Applicant: Wisconsin Alumni Research Foundation, Madison, WI (US)

(72) Inventors: Matthew Gebbie, Madison, WI (US); John McAlpine, Madison, WI (US); Hrishikesh Tupkar, Madison, WI (US)

(21) Appl. No.: 18/910,720

(22) Filed: Oct. 9, 2024

Related U.S. Application Data
(60) Provisional application No. 63/589,238, filed on Oct. 10, 2023.

(51) Int. Cl. H01G 11/02; H01G 11/26; H01G 11/62; H01G 11/84

(52) U.S. Cl. CPC H01G 11/02; H01G 11/26; H01G 11/62; H01G 11/84

(57) ABSTRACT

A method of amplifying interfacial capacitance in an electrochemical storage device may comprise applying a voltage to a porous metal electrode of an electrochemical storage device, the electrochemical storage device comprising the porous metal electrode; an electrolyte forming an interface with a surface of the porous metal electrode, the electrolyte comprising an ionic liquid and a redox active metal ion; and a counter electrode in electrical communication with the porous metal electrode. At the voltage applied, the electrochemical storage device exhibits an increased capacitance as compared to the electrochemical storage device at the voltage applied but absent the redox active metal ion. Also provided are the electrochemical storage devices.

### CROSS-REFERENCE TO RELATED APPLICATIONS

The present application claims priority to U.S. provisional patent application No. 63/589,238 that was filed Oct. 10, 2023, the entire contents of which are incorporated herein by reference.

### REFERENCE TO GOVERNMENT RIGHTS

This invention was made with government support under W911NF-23-1-0001 awarded by the Army Research Office, Department of Defense. The government has certain rights in the invention.

### BACKGROUND

Increased need to lower carbon emissions associated with energy use is leading to increasing utilization of renewable sources of energy, such as wind and solar energy, in electrical grids. Renewable sources of energy are inherently subject to fluctuations in power and energy density, which is accelerating the need for energy storage devices that can rapidly respond to level fluctuations in power associated with changes to solar and wind flux. For example, supercapacitors provide exciting opportunities for the future of energy storage due to a combination of fast charge-discharge kinetics, high safety, and long device lifetimes. Yet, the current generation of supercapacitors exhibit energy densities that are 10-100 times lower than that of lithium-ion batteries, limiting supercapacitor use to applications where the need for fast response times renders batteries impractical. Low energy density could be addressed by development of electrolytes with high capacitance and large voltage windows. Ionic liquid-based electrolytes are desirable in view of their nonflammability and large electrochemical stability windows. However, ionic liquid electrolytes have consistently exhibited low capacitances and thus have been unable to compete with current supercapacitor electrolytes.

### SUMMARY

The present disclosure is based on the unexpected discovery that the interfacial capacitance of ionic liquid electrolytes at electrode surfaces may be greatly enhanced by incorporating redox active metal ions into the ionic liquid electrolytes. This discovery may be leveraged to increase energy density in a variety of electrochemical storage devices, including supercapacitors. By way of illustration, the Example, below, reports bulk and electrochemical characterization of binary electrolyte mixtures containing the ionic liquid 1-butyl-3-methylimidazolium bis[(trifluoromethyl)sulfonyl]imide (BMImTFSI) and metal salts containing Li, Na, K, and Mg ions as well as ternary electrolyte mixtures containing two metal salts in BMImTFSI. Unexpectedly large enhancements in capacitance (e.g., greater than 350%) were observed from such mixtures. Moreover, the observed enhancement in capacitance at negative potentials within ternary salt mixtures suggests that highly tunable ionic networks exist within these electrolyte mixtures and that the differential capacitance may be tuned to improve metal ion activity. Such a dramatic increase in the energy density associated with electrochemical capacitors enables new devices that bridge the gap between conventional batteries, which exhibit poor response times, and existing capacitors, which exhibit low energy densities. The present innovation further enables the development and deployment of next-generation pseudocapacitive devices to achieve renewable energy grids with the reliability of current fossil fuel power generation.

In embodiments, a method of amplifying interfacial capacitance in an electrochemical storage device comprises applying a voltage to a porous metal electrode of an electrochemical storage device, the electrochemical storage device comprising the porous metal electrode; an electrolyte forming an interface with a surface of the porous metal electrode, the electrolyte comprising an ionic liquid and a redox active metal ion; and a counter electrode in electrical communication with the porous metal electrode. At the voltage applied, the electrochemical storage device exhibits an increased capacitance as compared to the electrochemical storage device at the voltage applied but absent the redox active metal ion.

In embodiments, an electrochemical storage device comprises a porous metal electrode; an electrolyte forming an interface with a surface of the porous metal electrode, the electrolyte comprising an ionic liquid and a redox active metal ion; and a counter electrode in electrical communication with the porous metal electrode. At a voltage applied to the porous metal electrode that is less negative the redox active metal ion's equilibrium potential, the electrochemical storage device exhibits an increased capacitance as compared to the electrochemical storage device at the voltage applied but absent the redox active metal ion.

Other principal features and advantages of the disclosure will become apparent to those skilled in the art upon review of the following drawings, the detailed description, and the appended claims.

### BRIEF DESCRIPTION OF THE DRAWINGS

Illustrative embodiments of the disclosure will hereafter be described with reference to the accompanying drawings.

FIG. 1A shows the chemical structure of 1-butyl-3-methylimidazolium bis[(trifluoromethyl)sulfonyl]imide (BMImTFSI) and the relative sizes of the ions tested. FIG. 1B depicts different mechanisms for capacitance in electrolyte systems. Underpotential deposition and ion intercalation are pseudocapacitive. FIG. 1C depicts the capacitance versus voltage curve of a hypothetical ionic liquid. The peak capacitances are present when the surface is completely saturated with ions, the decay in capacitance is a result in the ions in the system not being able to completely screen the charge of the electrode surface in a monolayer, increasing the double layer thickness.

FIG. 2 shows the potential-dependent capacitance exhibited by increasing concentrations of LiTFSI in BMImTFSI. Capacitance is highest in the 10 mol % LiTFSI mixture at negative voltages and highest in neat BMImTFSI at positive potentials.

FIG. 3A shows the potential-dependent capacitance of 10% metal salts in BMImTFSI on a gold surface. The highest capacitance is observed in the NaTFSI mixture at negative potentials and the KTFSI mixture at positive potentials. FIG. 3B shows that capacitance baselines decrease with increasing Mg(TFSI)₂ concentration.

FIG. 4A shows the potential-dependent capacitance of 10% metal salts in BMImTFSI on a glassy carbon surface. FIG. 4B shows the potential-dependent capacitance of neat BMImTFSI and 10% LiTFSI mixture on a copper surface.

FIGS. 5A-5C show a comparison of capacitance in ternary mixtures consisting of (FIG. 5A) 5% Li, 5% K, (FIG. 5B) 5% Li, 5% Na, and (FIG. 5C) 5% Na, 5% K in BMImTFSI.

FIGS. 6A-6B show capacitance after first, tenth, and hundredth cycle in neat BMImTFSI (FIG. 6A) and in BMImTFSI with 10% Li (FIG. 6B).

FIGS. 7A-7C show Raman spectra and deconvolution of ternary mixtures. FIG. 7A shows 5 mol % LiTFSI and 5 mol % KTFSI with BMImTFSI. FIG. 7B shows 5 mol % LiTFSI and 5 mol % NaTFSI with BMImTFSI, and FIG. 7C shows 5 mol % NaTFSI and 5 mol % KTFSI. The topmost line is the summation of all deconvoluted peaks and the black dots are the spectroscopic data. Peaks are labeled corresponding to which cation TFSI is likely coordinating to, BMIm, lithium, sodium, or potassium.

FIGS. 8A-8F show X-Ray photoelectron spectra of (FIG. 8A) 10% Li (FIG. 8B) 10% Na and (FIG. 8C) 10% K on clean Au film, Au film held at open circuit voltage and under reductive deposition potentials. Also reported are spectra of Cu surfaces held under the same conditions in (FIG. 8D) 10% Li (FIG. 8E) 10% Na and (FIG. 8F) 10% K. The Na 1s orbital is observed after deposition in both cases and Li Is orbital on Cu surface. Li deposition on gold is inconclusive due to overlapping orbitals and there is no clear indication of K deposition on either surface.

FIG. 9 is a schematic of an energy storage device according to an illustrative embodiment.

### DETAILED DESCRIPTION

The present disclosure is based on the unexpected discovery that the interfacial capacitance of ionic liquid electrolytes in contact with certain electrode surfaces can be greatly amplified by doping the ionic liquid electrolytes with certain redox active metal ions. Devices based on these doped ionic liquid electrolytes are provided which comprise an interface formed between an electrolyte and an electrode surface, the electrolyte comprising an ionic liquid and a redox active metal ion. The devices exhibit increased capacitance upon application of a voltage to the electrode surface as compared to the same devices but absent the redox active metal ion. As illustrated in the Example below, the extent of the amplification depends upon the applied voltage as well as the particular ionic liquid, redox active metal ion(s), and electrode surface that are selected, but unexpectedly large increases in capacitance may be achieved, e.g., greater than 350% as compared to the electrolyte absent the redox active metal ion(s).

The electrolyte of the present devices comprises (or consists of) an ionic liquid and a redox active metal ion. Ionic liquids are liquids composed of cations and anions and which generally have low melting temperatures, e.g., less than 100° C. In embodiments, the ionic liquid is one that is in its liquid phase at room temperature (20 to 25° C.). The ionic liquid may be selected on the basis of its electrochemical stability (i.e., resistance to electrochemical decomposition) over an operating voltage range (or at a specific operating voltage) of the device. The magnitude of this voltage range may be referred to as the electrochemical stability window of the ionic liquid and ionic liquids having relatively large electrochemical stability windows are desirable. In embodiments, the ionic liquid is characterized by an electrochemical stability window of at least 3 V, at least 4 V, at least 5 V, or at least 6 V. Electrochemical stability windows within a range of between any of these values are also encompassed, e.g., from 3 V to 6 V. In embodiments, the cation of the ionic liquid is an organic cation comprising carbon atoms. Illustrative organic cations include pyrrolidinium, piperidinium, and imidazolium (e.g., 1-butyl-3-methylimidazolium). Other illustrative cations include ammonium, phosphonium, boronium, and morpholinium. In embodiments, the anion is an organic anion comprising carbon atoms. Illustrative anions include sulfonimides (e.g., bis[(trifluoromethyl)sulfonyl]imide), borates, phosphates, sulfonates, halides, carbonates, and carboranes. An illustrative ionic liquid that may be used is 1-butyl-3-methylimidazolium bis[(trifluoromethyl)sulfonyl]imide (which may be referred to herein as BMImTFSI or [C₄MIm][TFSI]). Other ionic liquids that may be used include: (trimethylamine)(dimethylethylamine)dihydroborate bis[(trifluoromethyl)sulfonyl]imide[NNBH₂][TFSI]; triethyl(2-methoxyethyl)phosphonium bis[(trifluoromethyl)sulfonyl]imide [P_{2,2,2(201)}][TFSI]; 1-ethyl-2,3-dimethylimidazolium closo-carbadodecaborate [C₂MMIm][CB11H12]; (trimethylamine)(dimethylethylamine)dihydroborate hexafluorophosphate [NNBH₂][PF₆]; triethyl(2-methoxyethyl)phosphonium hexafluorophosphate [P_{2,2,2(201)}][PF₆]; 1-ethyl-2,3-dimethylimidazolium hexafluorophosphate [C₂MMIm][PF₆]; (trimethylamine)(dimethylethylamine)dihydroborate tetrafluoroborate [NNBH₂][BF₄]; triethyl(2-methoxyethyl)phosphonium tetrafluoroborate [P_{2,2,2(201)}][BF₄]; and 1-ethyl-2,3-dimethylimidazolium tetrafluoroborate [C₂MMIm][BF₄].

Regarding the redox active metal ion in the electrolyte, by “redox active” it is meant that the metal ion is one that undergoes electron transfer with the electrode at the operating voltage(s) of the present device. Thus, the redox active metal ion may be selected on this basis. In addition, the redox active metal ion may be selected on the basis of its size relative to the material of the selected electrode. Redox active metal ions having ionic radii sufficiently small to fit between atoms of the selected electrode may be particularly suitable. Finally, the redox active metal ion may be selected on the basis of its ability to be dissolved by the selected ionic liquid. In embodiments, the redox active metal ion is a metal cation provided by a metal salt present in the electrolyte. In embodiments, the metal cation is an alkali metal cation, e.g., Li⁺, Na⁺, K⁺. Although alkaline earth metal cations, e.g., Mg²⁺, may be used in some embodiments, in other embodiments such cations are not used. Other metal cations that may be used include Zn²⁺, Ca²⁺, Al³⁺, La³⁺, and Fe³⁺. The metal salt is composed of the metal cation and an anion. In embodiments, the anion of the metal salt is the same as the anion of the ionic liquid in the selected electrolyte (which anions have been described above). Illustrative metal salts include lithium bis[(trifluoromethyl)sulfonyl]imide, sodium bis[(trifluoromethyl)sulfonyl]imide, potassium bis[(trifluoromethyl)sulfonyl]imide, and magnesium bis[(trifluoromethyl)sulfonyl]imide. Other illustrative metal salts include those composed of any of the metal cations disclosed above and any of the ionic liquid anions disclosed above.

A single type of redox active metal ion (metal salt) may be used or multiple, different types may be used. For example, in embodiments, a single type of metal salt is used such that the electrolyte is a binary mixture of the ionic liquid and the metal salt. In other embodiments, two different types of metal salts are used such that the electrolyte is a ternary mixture of the ionic liquid and the two metal salts.

The electrode of the present devices, the surface of which forms an interface with the electrolyte and at which surface electron transfer with redox active metal ions occurs, comprises (or consists of) a metal (or metal alloy). However, the metal is of a different type than the selected redox active metal ion. Illustrative metals include gold, copper, and silver. Other electrode materials that may be used include a cuprate, a Heusler intermetallic, or an oxide (e.g., zinc oxide). However, some electrode materials may be excluded such as carbon (e.g., graphene, graphite); lithium (whether in metallic form or as a compound thereof); and a compound into which the redox active metal ion intercalates within the operating voltage range of the device. Thus, in embodiments, the electrode does not comprise and is not composed of any such electrode materials (i.e., carbon, lithium, intercalating compound). With respect to carbon in particular, the phrase “metal electrode” (and the like) as used herein excludes carbon.

The electrode of the present devices is desirably porous so as to provide a large surface area, and thus, large electrode-electrolyte interfacial area. In porous electrodes, the material of the electrode (metal or metal alloy as described above) is a solid matrix, the surfaces of which define a plurality of pores distributed throughout. The pores may be macropores having an average dimension of greater than 50 nm. The pores may be micropores having an average dimension of less than 2 nm. Both macropores and micropores may be present. These average dimensions refer to a maximum distance between opposing surfaces defining the pores. The use of porous electrodes is by contrast to electrochemical devices in which electrode surface area is desirably minimized, e.g., batteries.

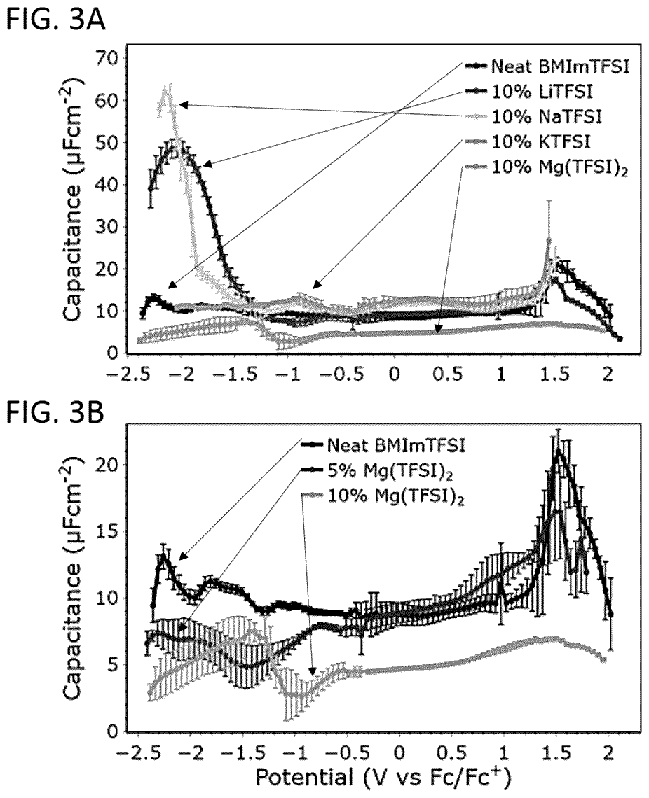

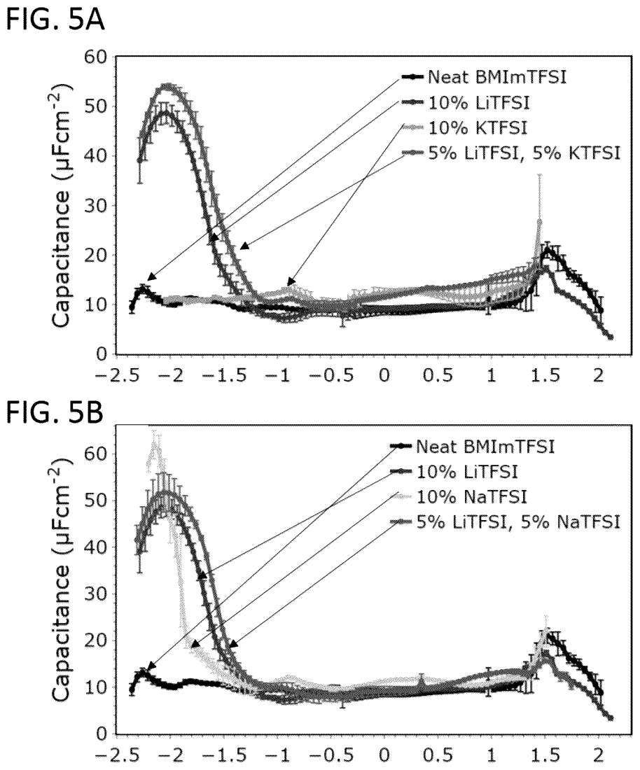

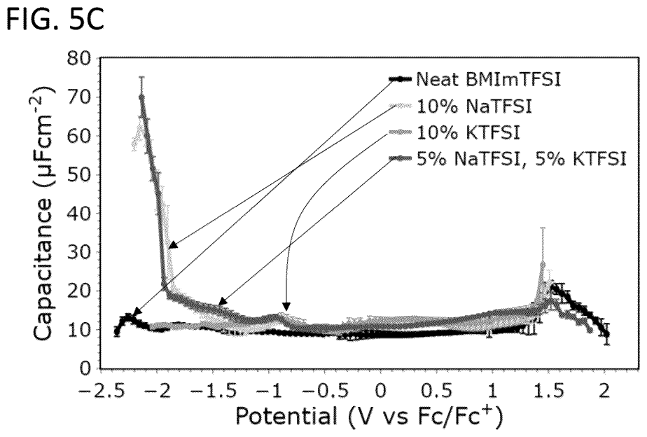

Although a variety of ionic liquids, redox active metal ions, and electrodes may be used, as demonstrated in the Example, below, it is the particular combination of these components that determines whether an increased capacitance is realized. Moreover, as illustrated in the Example, below, particular combinations have been found to exhibit unexpectedly large increases in capacitance and surprisingly, size and electronegativity are not the sole determinants of capacitive enhancement. For example, an increase of greater than 500% in capacitance was observed using an electrolyte composed of 1-butyl-3-methylimidazolium bis[(trifluoromethyl)sulfonyl]imide (ionic liquid) and sodium bis[(trifluoromethyl)sulfonyl]imide (metal salt) in contact with a gold electrode as compared to the electrolyte absent the metal salt. (See FIG. 3A.) However, capacitance actually decreased using an electrolyte composed of the same ionic liquid but using magnesium bis[(trifluoromethyl)sulfonyl]imide in contact with the gold electrode. FIG. 5C further shows that although potassium bis[(trifluoromethyl)sulfonyl]imide alone does not achieve increased capacitance, mixtures of this metal salt with sodium bis[(trifluoromethyl)sulfonyl]imide do, including to capacitance values that actually exceed that of electrolytes that use only sodium bis[(trifluoromethyl)sulfonyl]imide. Thus, the experimental data enclosed herein demonstrates that although a complex combination of ion-ion interactions and ion-electrode interactions must be balanced to realize the enhanced capacitance, certain combinations of ionic liquid, redox active metal ion, and electrode may be selected to achieve substantial increases in capacitance.

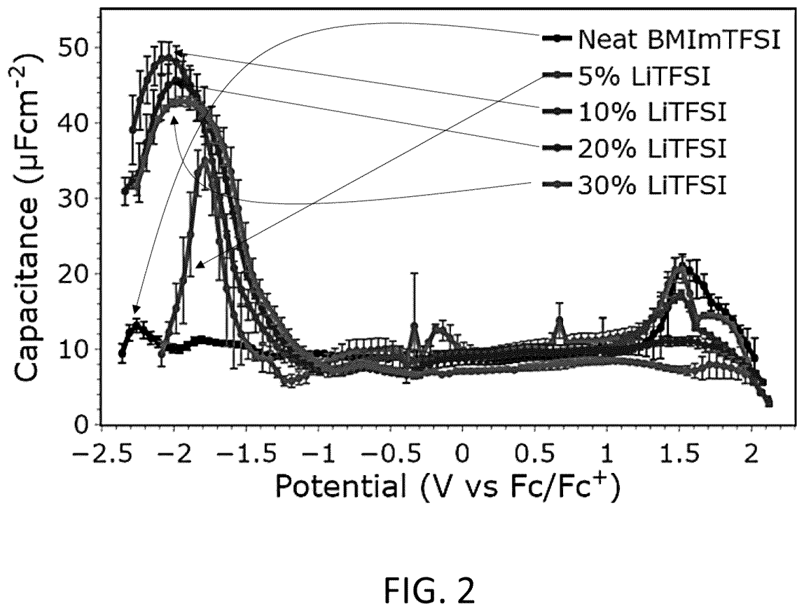

In addition to selection of these components, as illustrated in the Example below, the amount of redox active metal ion (metal salt) in the electrolyte may be selected to achieve a desired increase, e.g., maximum, in capacitance. The amount may be referred to as a mole percent value, i.e., (moles of metal salt)/(total moles of metal salt+ ionic liquid)*100. In embodiments, the amount of redox active metal ion (metal salt) is no more than 12 mole percent, no more than 10 mole percent, or no more than 8 mole percent. This includes a range between any of these values and from 7 to 13 mole percent and 9 to 11 mole percent. If more than one type of redox active metal ion (metal salt) is present in the electrolyte, the amounts of each may be independently selected within the ranges above or the total amount may be within the ranges above. The influence of the amount of the redox active metal ion on capacitance is shown in FIG. 2.

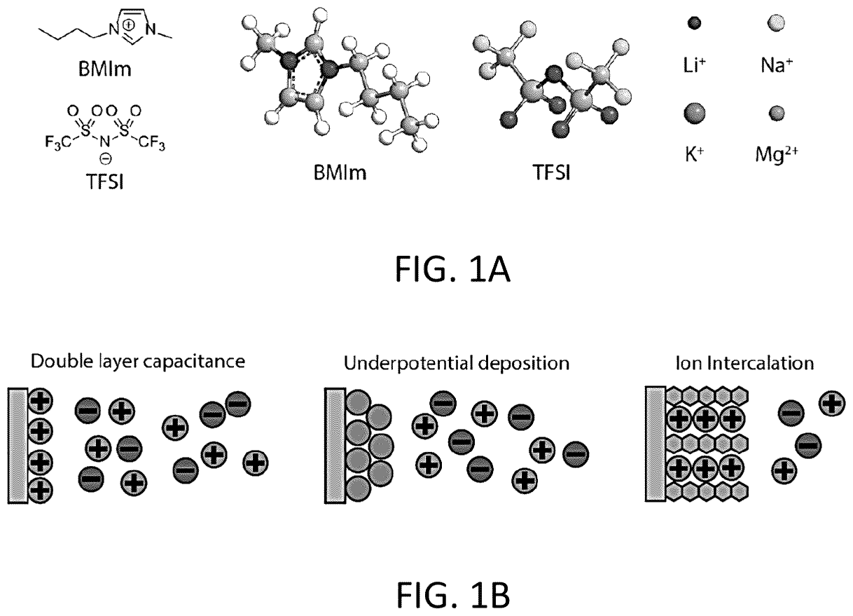

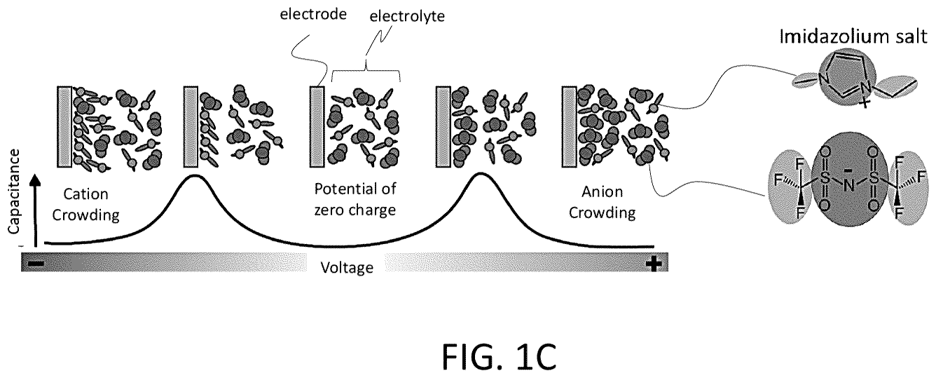

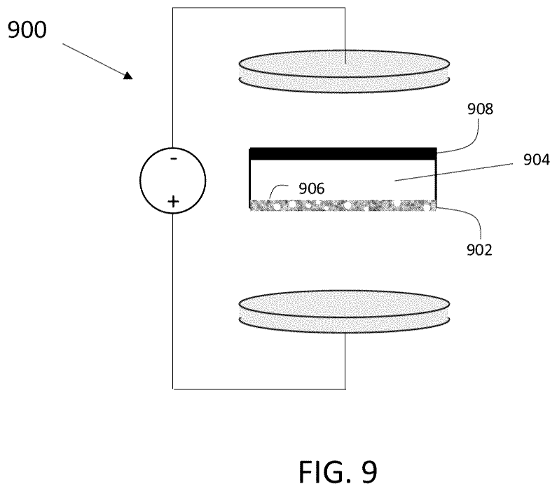

The present devices comprise a counter electrode in electrical communication with the electrode and a voltage source configured to apply a voltage(s) to the electrode. Materials that may be used for the counter electrode include carbon, titanium, zinc, iron, iron phosphate, copper, gold, silver, platinum, and nickel-manganese-cobalt oxide. The counter electrode may comprise (or consist) of any of these materials. Depending upon its exact configuration, the device may be a capacitor or another electrochemical device, e.g., a battery. However, some devices may be excluded, e.g., a lithium metal battery and a lithium-ion battery. A portion of a capacitor is shown in FIG. 1C (the counter electrode is not shown). Another device 900 is shown in FIG. 9 which includes a porous metal electrode 902, an electrolyte 904 forming an interface 906 with a surface of the porous metal electrode 902, the electrolyte 904 comprising an ionic liquid and a redox active metal ion, and a counter electrode 908 in electrical communication with the porous metal electrode 902. Shown, but not labeled in the device 900 are top and bottom caps. Any of the disclosed porous metal electrodes, electrolytes, ionic liquids, redox active metal ions, and counter electrodes may be used in the device 900.

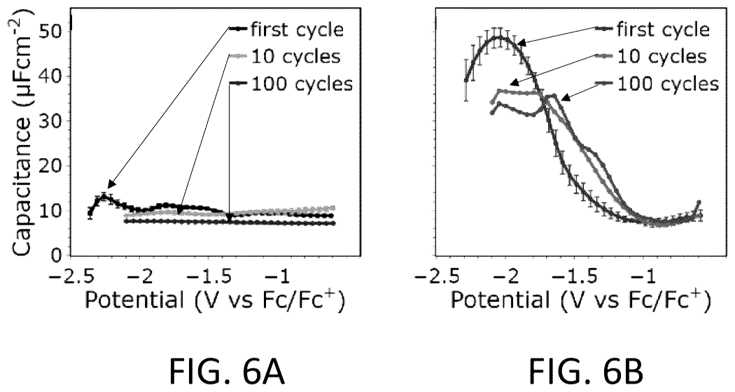

Methods of using the present devices are also provided which comprise applying a voltage to the electrode. The voltage applied may be characterized by its polarization (i.e., negative or positive) and its magnitude. The polarization and magnitude may be selected to achieve a desired capacitance, e.g., maximum capacitance. A range of voltages may be applied, e.g., as shown in FIGS. 2-5C, and this range may be referred to as the operating voltage range of the present device. This range may span the electrochemical stability window of the selected ionic liquid. However, the applied voltage includes a voltage less negative than the redox active metal ion's equilibrium potential. Moreover, voltages are not used which would result in deposition of the redox active metal ion onto itself. The methods may involve cycling over the desired operating voltage range. As shown in FIG. 6B, the capacitive enhancements have been found to be both reversible and robust.

As noted above, the present devices are characterized by exhibiting an increased capacitance as compared to the same device with the same electrolyte but absent the redox active metal ion and substantial increases in capacitance may be achieved. Capacitance may be measured as described in the Example, below. In embodiments, the present device exhibits a capacitance value that is at least 400% of the capacitance value of the same device with the same electrolyte but absent the redox active metal ion. This includes the present device exhibiting a capacitance value that is at least 450%, at least 500%, at least 550%, at least 600%, at least 650%, or at least 700% of the capacitance value of the same device with the same electrolyte but absent the redox active metal ion. Capacitance values within a range of between any of these values are also encompassed, e.g., from 400% to 700%. These values may refer to a maximum capacitance and the applied voltage that achieves the maximum capacitance.

As discussed in detail in the Example below, it is believed that the increased capacitance is due, at least in part, to the underpotential deposition of redox active metal ions in the electrolyte onto the electrode surface as induced by the applied voltage. Thus, the devices themselves may be characterized (under the applied voltage) as further including an amount of deposited redox active metal ion on the electrode surface. Due to the electron transfer that occurs, the redox active metal ions are reduced and converted into their neutral, metallic states, i.e., atomic metal. Thus, the deposited redox active metal ions may be characterized as a thin layer of the atomic metal on the electrode surface. The thickness of this layer corresponds to not more than one or two monolayers of the atomic metal. During operation of the devices and cycling of the voltage, this layer will form, disappear, reform, etc. It is noted that the deposition of redox active metal ions achieved as described herein is fundamentally different than ion intercalation. (See FIG. 1B.) In the present methods and devices, the deposition of redox active metal ions results in a surface alloy composed of the atomic metal and the material of the electrode. Formation of this surface alloy is thermodynamically driven due to the lowering of electrode-electrolyte interfacial energies. By contrast, ion intercalation involves the incorporation of metal ions into a bulk material.

The present devices (e.g., capacitors) may be included as a component of any system in which capacitors are used.

### Example

This Example explores how underpotential deposition provides a mechanism for pseudocapacitive energy storage in ionic liquids by using ions that undergo surface redox reactions under conditions where ion crowding often compromises capacitance. This Example investigates how different alkali metal salts containing lithium, sodium, potassium, and magnesium ions perform at different interfaces when mixed with the ionic liquid 1-butyl-3-methylimidazolium bis(trifluoromethylsulfonyl)imide ([C₄MIm][TFSI])(FIG. 1A), with a focus on capacitive enhancement of interfaces. The results reveal unexpected and dramatic increases in capacitance from certain salt-in-ionic liquid mixtures as well as high reversibility of this process with no indication of capacitive decline. Further, this Example shows how mixtures of different redox ions in ionic liquids alter bulk ionic coordination to promote metal ion-electrode surface interactions to increase electrode-electrolyte interfacial capacitance.

### Materials and Methods

Chemicals. In all experiments, the ionic liquid [C₄MIm][TFSI](≥99% purity, Iolitec) was used. For purification, the ionic liquid was diluted with ethyl acetate and was treated with activated charcoal. The solution was stirred at room temperature for two days. Charcoal was removed via vacuum filtration and the solution filter solution was run through an activated alumina column with ethyl acetate as the mobile phase. Ethyl acetate was removed using rotary evaporation and the ionic liquid was dried at 100° C. under vacuum for two days. After purification, the ionic liquid was colorless and clear at room temperature. Metal salts [Li][TFSI](>98.0% purity, TCI), [Mg][(TFSI)₂](>97.0% purity, TCI), [Na][TFSI](>98.0% purity, TCI), and [K][TFSI](>99.5% purity, Solvionic) were used as received. Preparation of salt mixtures consisted of mixing respective salts with [C₄MIm][TFSI] in appropriate molar quantities and drying at 100° C. under vacuum for two days. All chemicals were stored in an argon-filled glovebox to mitigate the influence of water on electrochemical properties.

Electrochemical Characterization. Electrochemical measurements were performed in an argon-filled glovebox using a three-electrode setup and a Biologic SAS SP-300 potentiostat. An electrochemical cell was designed, consisting of a 3D-printed polylactic acid cap inserted onto a machined polypropylene base containing a sample well. A polycrystalline gold electrode (BASi, geometric surface area of 0.071 cm²) and a glassy carbon electrode (BASi, geometric surface area of 0.071 cm²) were used as working electrodes. The gold electrode was polished prior to each electrochemical experiment as follows. First, using 1 μm diamond polish, the electrode was moved in a figure eight pattern over a diamond polishing pad two hundred times; every fifty cycles the electrode was rotated ninety degrees. The electrode was washed with water after this initial polishing. Next, the same procedure was performed using an 0.05 μm alumina slurry and an alumina polishing pad. The electrode was sonicated in water for two minutes to remove adsorbed alumina. Finally, the electrode was washed with water, then methanol, and air dried. Following each electrochemical experiment, the working electrode was held at −1 V vs the reference electrode for one hour to remove anything adsorbed to the working electrode surface that could not be removed with mechanical polishing. The same procedure was used with the glassy carbon electrode except that no diamond polish was used. For the copper surface the same polishing procedure was performed as with gold. Before conducting EIS trials, the copper electrode was held at a −1 V bias vs the reference electrode in [C₄MIm][TFSI] to remove any oxide layer that had formed. The solution was replaced before starting EIS experiments. A silver/silver sulfide nonaqueous reference electrode was used, which was designed for use with ionic liquids by Lawrence Livermore National Laboratories. A 100 nF capacitor was soldered to the reference electrode to bypass high reference electrode impedance. This electrode was standardized against the ferrocene/ferrocenium redox pair. A coil of platinum wire was used as the counter electrode.

Cyclic voltammetry was conducted at a scan rate of 5 mV/s to confirm the electrochemical window of each metal salt-ionic liquid mixture. Using the measured electrochemical window, staircase potentio-electrochemical impedance spectroscopy (SPEIS) measurements were conducted, beginning at the open circuit potential and ending at either the positive or negative side of the electrochemical stability window. Impedance spectroscopy was performed in 50 mV intervals. Differences in capacitance measurements can occur if the scan is begun at either limit of the electrochemical stability window and finished at the other limit. At each voltage step, impedance spectra were collected using a 10 mV sinus amplitude over a 100 kHz to 1 Hz frequency range. Ten points were collected every decade resulting in a total of 51 frequencies being tested per voltage increment.

For each voltage step measured using SPEIS, impedance was converted to capacitance using the inverse relationship shown in Eq. 2:

$$\hat{C} ( ω ) = \frac{1}{i ω \hat{Z} ( ω )} \qquad ( 2 )$$

The transformed capacitance data was plotted on a complex capacitance plane, with the real component of capacitance represented on the x-axis and the imaginary component represented on the y-axis. The resulting capacitance spectrum was fitted using the Cole-Cole equation to effectively model double layer capacitance, Eq. 3.

$$\hat{C} ( ω ) = {\sum }_{i} \frac{{c}_{i}}{1 + {( i ω {τ}_{i} )}^{{α}_{i}}} + {C}_{0} \qquad ( 3 )$$

where τᵢ is a component time constant and αᵢ is a parameter accounting for nonidealities in the system. The Cole-Cole equation accounts for different capacitive processes occurring in an electrochemical system through summation. Each capacitance spectrum resulted in two semicircles over varying frequency ranges, with one contributing toward faster capacitive processes such as double layer charging and the other contributing toward slower capacitive processes. The semicircle representative of double layer charging was used to determine capacitance at each voltage step. Over the double layer charging timescale, the ai values approach a value of 1, a characteristic of ideal capacitors. Therefore, the capacitance of the system at each voltage was determined purely from a summation of capacitive contributions due to electric double layer formation.

CV was also conducted at negative potentials on a gold working electrode to observe reductive peaks exhibited by underpotential deposition. Neat [C₄MIm][TFSI], 10% [Li][TFSI] and 10% [K][TFSI] mixtures were cycled from 0.2 V to −1.3 V vs the reference electrode. 10% [Na][TFSI] was cycled from 0.2 V to −1.5 V vs the reference electrode since underpotential deposition occurred at more negative voltages. A ZIR correction was applied by the potentiostat prior to the first CV scan. Three cycles of CVs were performed at 50, 40, 30, 25, 20, 10, and 5 mV/s scan rates subsequently.

Raman Spectroscopy Measurements. Raman spectra were taken on a LabRAM HR Evolution Horiba microscope using a 532 nm laser and grating of 1800 grooves per millimeter. All Raman spectra were fitted and processed using Horiba's LabSpec6 software. Samples were sealed in glass slides inside of an argon glovebox using paraffin wax before spectra were taken.

X-Ray Photoelectron Spectroscopy Measurements. To prepare surfaces for X-ray photoelectron spectroscopy, 26 nm of gold from gold pellets (99.999%, Kurt Lesker) were deposited onto one side of a 1.5 mm by 6 mm copper foil using an Edwards AUTO 306 Vacuum Coater. For each mixture, one foil was immersed at open-circuit voltage and another at deposition potentials previously determined by cyclic voltammetry for five minutes. The surfaces were then rinsed with acetone, ethanol, and dried prior to conducting XPS experiments to remove any ionic liquid. X-ray photoelectron spectra were taken on a Thermo K alpha X-Ray Photoelectron Spectroscopy equipped with a monochromatic Al Kα X-ray source (hv=1486.7 eV). All spectra were fitted and processed using Thermo Fisher Scientific's Advantage software. Binding energies were references to adventitious carbon (C 1s) at 284.5 Ev.

### Results

Connecting Electrolyte Composition to Capacitance. Electrochemical impedance spectroscopy (EIS) was performed to determine how interfacial capacitance varies with the addition of different metal cations into [C₄MIm][TFSI]. The impedance of electrochemical cells was collected by applying an oscillating sine wave of 10 mV amplitude over a 100 kHz to 1 Hz frequency range at applied direct current biases. Stepping biases in 50 mV increments, direct current responses were measured in cathodic and anodic directions respectively within the electrolyte's electrochemical stability window. Using Cole-Cole modeling, as detailed in the methods section, the capacitance of the electrode-electrolyte interface was determined at each selected potential. Capacitance depends on electrolyte composition, electrode material, and electrode surface morphology. All capacitance values were normalized by the geometric electrode surface area. While the actual electrochemically active surface area can vary between experiments and electrodes, trends were consistent between different electrolyte compositions and electrode materials. Electrochemical stability windows of each mixture were determined using cyclic voltammetry and reported differential capacitance values only within this window.

The study began by analyzing mixtures of [Li][TFSI] and [C₄MIm][TFSI] on gold electrodes. Four different mixtures of [Li][TFSI] and [C₄MIm][TFSI] were studied, x=0.05, 0.10, 0.20, and 0.30 mol fractions lithium salt (FIG. 2). It was observed that increasing the concentration of lithium cations added to [C₄MIm][TFSI] increased the capacitance at negative polarizations in comparison to neat [C₄MIm][TFSI]. In contrast, the addition of lithium decreased the interfacial capacitance at positive polarizations compared to neat ionic liquid.

The capacitance at negative bias reached a maximum for the x=0.10 mixture at a value ca. 49 μ Fcm⁻², and the capacitance slightly decreased as the lithium concentration was further increased to x=0.30. Capacitance measurements at polarizations closer to open circuit potential were similar or identical, within error, to those of neat [C₄MIm][TFSI] for all lithium concentrations studied. Mixtures containing x=0.40 mol fraction [Li][TFSI] were also studied. After impedance measurements in the x=0.40 samples, the electrode exhibited white precipitate on the gold surface.

After detailed study of [C₄MIm]-[Li]-[TFSI], EIS of other [C₄MIm]-metal cation mixtures was performed using gold electrodes. Binary mixtures of [Na][TFSI], [K][TFSI], or [Mg][(TFSI)₂] at concentrations of x=0.05 and 0.10 in [C₄MIm][TFSI] were studied. These compositions were selected since [Na][TFSI], [K][TFSI], and [Mg][(TFSI)₂] are less soluble in [C₄MIm][TFSI] than [Li][TFSI]. Testing of solutions of 5 mol % [Zn][(TFSI)₂] or 5 mol % [Ca][(TFSI)₂] in [C₄MIm][TFSI] was attempted. These solutions either contained a solid precipitate or a gel phase and further experimentation was not conducted.

For [Na][TFSI] mixtures, the capacitance at negative potential exceeded those of the [Li][TFSI] mixtures with a maximum value of ca. 62 μ Fcm⁻². In contrast, mixtures containing [K][TFSI] did not show changes in capacitance at negative polarizations when compared to neat [C₄MIm][TFSI], suggesting that K⁺ cations either do not accumulate at gold surfaces under the applied polarizations or solutions of [C₄MIm]-[K]-[TFSI] form electric double layers that exhibit capacitance that is surprisingly similar to neat [C₄MIm][TFSI] (FIG. 3A).

Interestingly, a decrease in capacitance was observed over the entire voltage window with addition of [Mg][(TFSI)₂] to [C₄MIm][TFSI] when compared to neat [C₄MIm][TFSI], including at open circuit potential. Further, a clear trend in capacitance was not found with increasing [Mg][(TFSI)₂]concentration. 10% [Mg][(TFSI)₂] peaked at a higher cathodic capacitance than 5% [Mg][(TFSI)₂] but exhibited a steeper decline at increasing bias (FIG. 3B). However, baseline capacitance consistently decreased with increasing [Mg][(TFSI)₂] concentration. Hence, addition of a higher charge density cation appeared to enhance ionic correlations within the electrolyte relative to [C₄MIm][TFSI], which resulted in the formation of a less effective screening interface. This suggests that either Mg²⁺ cations do not accumulate at interfaces or the presence of Mg²⁺ cations yields a more crowded interfacial environment.

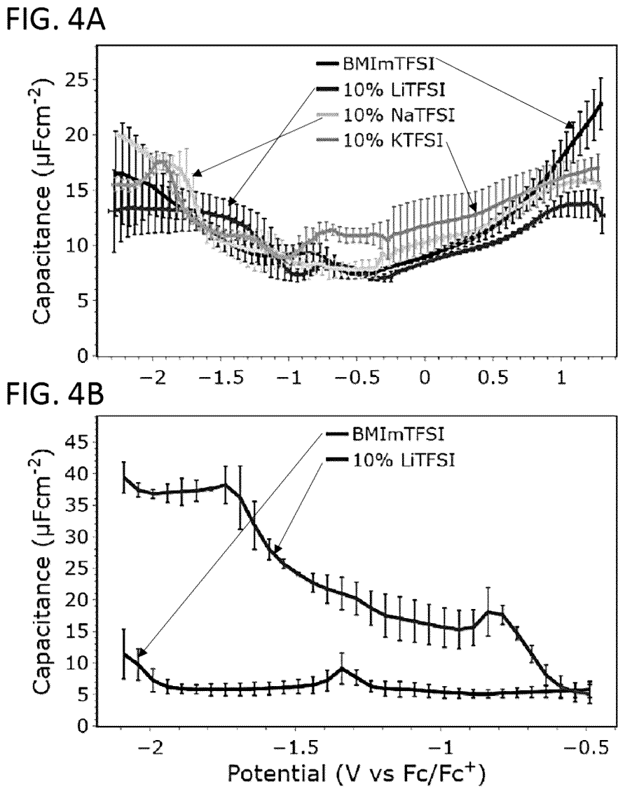

After analyzing gold surfaces, similar EIS experiments were repeated using glassy carbon electrodes. Mixtures of [Li][TFSI], [Na][TFSI], or [K][TFSI] with [C₄MIm][TFSI] at concentrations of x=0.10 were studied, as this composition showed the clearest trends in analysis at gold electrodes. Notably, the capacitance of [Li][TFSI] containing mixtures was found to be lower than neat [C₄MIm][TFSI] capacitance at both cathodic and anodic polarizations. The most prominent difference was observed at anodic polarizations, where the capacitance was 21 μFcm⁻² in neat [C₄MIm] [TFSI] at the same voltage where a capacitance peak of 14 μ Fcm⁻² in 10% [Li][TFSI] (FIG. 4A) was observed. Further, differential capacitance measured on mixtures containing [Na][TFSI] and [K][TFSI] exhibited the same behaviors as that of the [Li][TFSI] mixtures, indicating that metal cations minimally perturbed electric double layer formation at glassy carbon electrodes.

In contrast, the capacitance measured at positive bias increased with bare ion radius, Li<Na<K, when using glassy carbon electrodes. At the most positive potentials, neat [C₄MIm][TFSI] consistently exhibited greater capacitance than metal salt containing mixtures, suggesting that the presence of metal cations reduces the screening efficiency of electric double layer formation, which could be related to the fact that metal cations are known to form coordination complexes with TFSI anions. Importantly, these results suggest that the substantially enhanced capacitance observed at the gold-ionic liquid interface was due to the presence of a process that occurred at the gold-ionic liquid interface but was absent at the carbon-ionic liquid interface.

To determine if the enhanced capacitance measured at the gold-ionic liquid interface extended to other metal surfaces, EIS was performed for neat [C₄MIm][TFSI] and a x=0.10 [Li][TFSI] mixture on copper electrodes. Due to oxidative reconstruction and formation of insulating oxides under anodically-polarized copper surfaces, interfacial capacitance was only evaluated at potentials negative of open circuit potential. The differential capacitance of the [Li][TFSI] containing mixture was greater than or equal to that of the neat ionic liquid (FIG. 4B).

To further investigate the impact of ionic correlations, EIS was performed on ternary alkali metal salt mixtures of [Li][TFSI]/[K][TFSI], [Li][TFSI]/[Na][TFSI], and [Na][TFSI]/[K][TFSI], each at 0.05 mol fraction metal salt in [C₄MIm][TFSI] on a gold electrode. (FIGS. 5A-5C.) All three mixtures exhibited high capacitances exceeding x=0.10 [Li][TFSI] in [C₄MIm][TFSI] at negative potentials, with [Na][TFSI]−[K][TFSI] mixtures having the highest capacitance of 70 μ Fcm⁻². Both sodium-containing ternary mixtures resulted in capacitances lower than those observed in neat [C₄MIm][TFSI] at positive voltages. [Li][TFSI]−[Na][TFSI] exhibited a capacitance of ca. 15 μFcm⁻² and [Na][TFSI]−[K][TFSI] peaked at ca. 17 μ Fcm⁻².

Evaluating Reversibility of Salt-in-Ionic Liquid Electrolytes. To evaluate the reversibility of lithium-mediated capacitance enhancement in salt-in-ionic liquid electrolytes, multiple cyclic voltammograms (CVs) were run between EIS trials. Irreversible solid electrolyte interphase formation can exhibit similar charge transfer features as observed in Nyquist plots and are interpreted as signatures of lithium underpotential deposition. Ten CVs were run from −0.6 V to −2.1 V referenced versus ferrocene at a scan rate of 25 mV/s. Then, EIS was performed from −0.6 V to −2.1 V following the same parameters previously described. Ninety more CVs were run following the same parameters as before and EIS was conducted again. The CVs were voltage corrected using the “ZIR” function in the EC-lab software with a frequency of 100 kHz and a sinus amplitude of 20 mV. Both neat [C₄MIm][TFSI] and a mixture of x=0.10 [Li][TFSI] and [C₄MIm][TFSI] were tested.

As shown in FIG. 6A, the capacitance of neat [C₄MIm][TFSI] decayed slightly from the first to tenth cycle, a maximum decrease of 11.0 μ Fcm⁻² to 8.9 μ Fcm⁻² respectively at −2.1 V. First cycle hysteresis is generally observed in electrochemical systems, even in the absence of electrolyte decomposition and results from a complex combination of interfacial processes, including surface reconstruction, ion adsorption, and reduction of native oxide layers. There was minimal observed change between the next 10 cycles and 100 cycles. As shown in FIG. 6B, for mixtures containing [Li][TFSI], the increase in the observed capacitance of the system occurred at a more positive potential. The capacitance at −2.1 V versus ferrocene decreased with cycle number. The magnitude of this decrease in capacitance reduced as the number of scans increased. Analogous reversibility was observed for other salt-in-ionic liquid-metal interfaces, demonstrating that underpotential deposition-mediated pseudocapacitance is a promising energy storage and release mechanism.

Bulk Spectroscopy to Understand Ion Solvation. Raman spectroscopy may be used to evaluate ion coordination environments in ionic liquids. The TFSI anion in ionic liquids has a well-studied vibration mode ca. 742 cm⁻¹, which has been assigned to stretching of the entire TFSI anion. In metal salts the mode is blue shifted. For example, in [Li][TFSI] the mode was ca. 747 cm⁻¹. When metal salts containing TFSI were mixed with ionic liquids that also contain TFSI, a convolution of peaks became present ca. 742 cm⁻¹. This convolution contained the mode ca. 742 cm⁻¹ and peaked at higher wavenumbers. These new peaks were thought to represent changes in the TFSI coordination environment. The lower energy Raman mode corresponded to TFSI coordinating with an organic cation and the higher energy modes corresponded to different ways TFSI can coordinate with a metal cation.

For mixtures of [C₄MIm][TFSI] and alkali metal salts, [Li][TFSI], [Na][TFSI], or [K][TFSI], the Raman mode ca. 742 cm⁻¹ could be deconvoluted into two different peaks. This deconvolution always contained a peak ca. 742 cm⁻¹ and the higher energy peak varied between alkali salts. For [Li][TFSI] mixtures there was a peak ca. 747 cm⁻¹, for [Na][TFSI] mixtures there was a peak ca. 745.5 cm⁻¹, and for [K][TFSI] mixtures there was a peak ca. 744 cm⁻¹. The ratio of the area of the neat [C₄MIm][TFSI] TFSI stretching mode ca. 742 cm⁻¹ to the area of the newly developed peak attributed to metal-TFSI coordination structures has been used to hypothesize coordination structures. By performing concentration-based studies as well as DFT and MD simulations, it has been proposed that two TFSI anions coordinate to a lithium ion while three TFSI anions coordinate to sodium and potassium ions.

Raman spectra of [C₄MIm][TFSI] mixtures with [Mg][(TFSI)₂] had a convolution of three different Raman modes ca. 742 cm⁻¹. As with the alkali metal salts, there was a peak ca. 742 cm⁻¹, the other two peaks were located ca. 747 cm⁻¹ and ca. 751 cm⁻¹. The peak ca. 751 cm⁻¹ was thought to be a bridging structure between three TFSI anions and two magnesium ions. The lower wavenumber peak, ca. 747 cm⁻¹ was thought to represent three TFSI molecules coordinating to a magnesium ion, akin to the coordination structure with sodium or potassium ions.

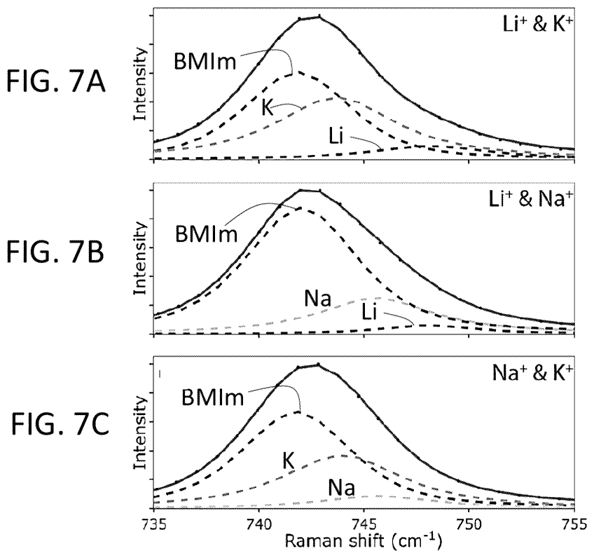

As shown in FIGS. 7A-7C, ternary mixtures of [C₄MIm][TFSI] and two of [Li][TFSI], [Na][TFSI], and [K][TFSI] were also evaluated using Raman spectroscopy. All spectra of these mixtures had a convolution of three peaks ca. 742 cm⁻¹. As with all previous mixtures tested, one of the peaks was located ca. 742 cm⁻¹. The location of the peak previously assigned to lithium ion complexation with TFSI was at ca. 747 cm⁻¹. In the ternary mixtures the [Li][TFSI] peak was located ca. 748 cm⁻¹. The higher energy Raman mode corresponding to metal ion TFSI complexation in the mixtures had a much lower intensity in comparison to the other metal ion TFSI complexation mode. Deconvolution using only two peaks was also tried to see if the highest energy peaks were a result of overfitting the spectra. When only two peaks were used to deconvolute the data, the fit did not accurately represent the data and the location of the third peak was clear.

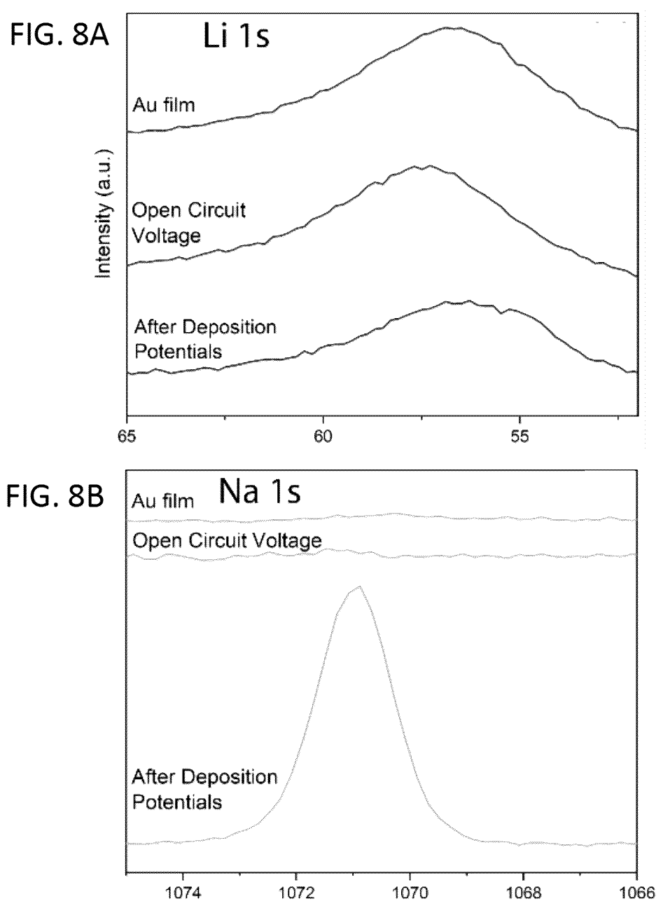

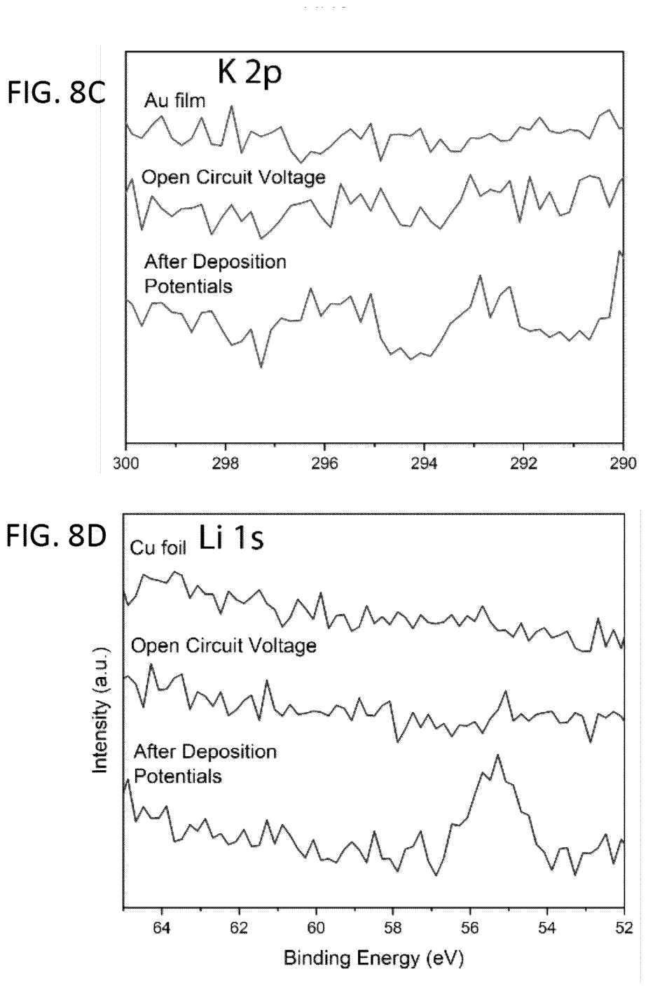

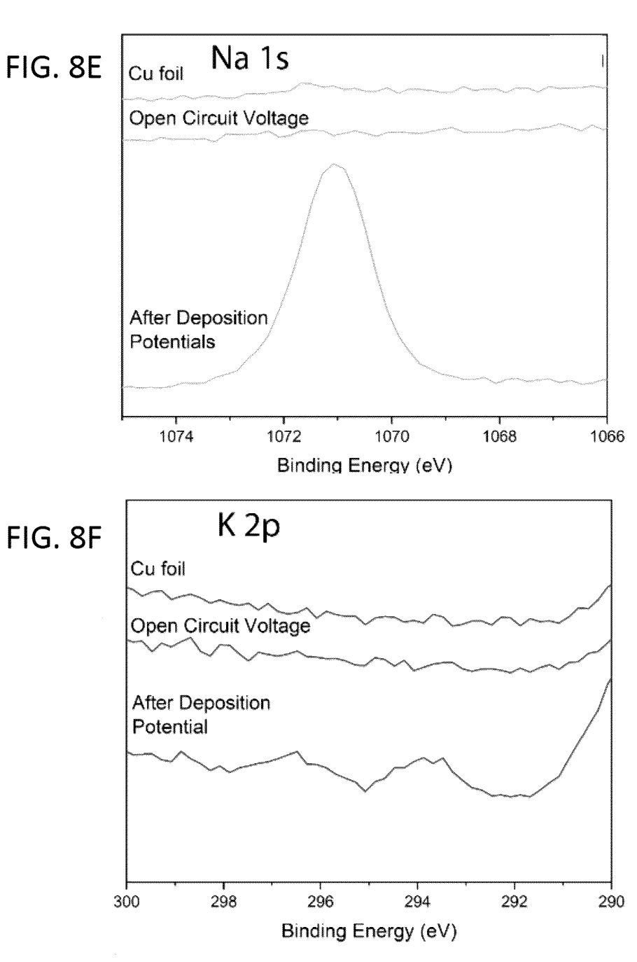

Analyzing underpotential Deposition onto Metal Surfaces. X-ray photoelectron spectroscopy (XPS) was conducted to confirm underpotential deposition onto negative metal surfaces. The expected binding energies of metals Li, Na, K, Au, and Cu were used to identify surface species. FIGS. 8A-8C show binding energies of Li Is, Na Is, and K 2p orbitals respectively on a gold surface. The Li Is orbital has a reported binding energy of 56 eV which overlaps with the Au 5p_{3/2} binding energy of 57 eV. Therefore, it is challenging to deconvolute this region and conclude lithium binding solely from this spectrum. Given that underpotential deposition of lithium onto copper was reported using impedance spectroscopy as well (FIG. 4B), lithium was indeed seen present at 57 eV on a copper surface after deposition (FIG. 8D). On both Au and Cu surfaces, sodium binding was observed, indicated by the peak at 1071 eV. In potassium mixtures, minimal presence of peaks at 294 eV and 297 eV was seen, which indicates minimal surface adsorption of potassium but no significant charge transfer occurring as a pseudocapacitive contribution on either gold or copper. Surfaces prepared in neat [C₄MIm][TFSI] exhibited the same peaks observed on Au or Cu, indicating that the Li Is and Na Is binding energies observed in salt-in-ionic liquid electrolytes were due to underpotential deposition (data not shown). Scans of elements present in the survey spectrum were also compared across all cases and significant presence was not seen of other elements before and after deposition. Therefore, the presence of Li or Na was likely not due to solid electrolyte interphase (SEI) formation and indeed a result of alkali metal deposition onto cathodic metal surfaces.

### DISCUSSION

It was found that underpotential deposition in salt-in-ionic liquid electrolytes substantially increased the interfacial capacitance of ionic liquid-metal interfaces under large applied potentials where ion crowding often compromises double layer capacitance. These findings demonstrate that capacitance boosted by underpotential deposition can play a transformative role in increasing the energy density of ionic liquid-based electrochemical capacitors.

Furthermore, the results show that underpotential deposition provides a generalizable mechanism for different alkali metals and electrode materials, but also that there are key distinctions in double layer formation and pseudocapacitive enhancement in different combinations of ionic liquid, metal cation, and electrode surface.

Comparison of interfacial capacitance at metal electrodes to glassy carbon electrodes emphasizes the role of pseudocapacitance in increasing total capacitance. Underpotential deposition of alkali metal ions on glassy carbon surfaces was not observed at the potentials tested. For gold and copper surfaces, enhanced capacitance in [Li][TFSI] containing mixtures was observed when compared to the neat material indicating underpotential deposition occurs on metal surfaces. X-Ray photoelectron spectra supported this pseudocapacitive behavior from the emergence of lithium or sodium peaks on gold or copper surfaces.

The resulting differential capacitances of ionic liquid and metal salt mixtures with a glassy carbon surface were a quarter of the value reported on gold. Although it was hypothesized that smaller ions would facilitate formation of a more densely packed nanostructure with increased screening, the decreased capacitance at glassy carbon surfaces indicated that this was not the case. Instead, capacitive enhancement mediated by alkali cations appeared to originate in pseudocapacitive surface reactions. This further emphasizes that leveraging both ion-electrode interactions in addition to ion-ion interactions within electrolyte systems is necessary to optimize capacitive performance.

To further distinguish how ion size and electronegativity impact interfacial capacitance, the behavior of metal cations Li, Na, or K in [C₄MIm][TFSI] was compared. If size or electronegativity of these metal cations were the driving factor in determining capacitive enhancement, the trend should have decreased with increasing metal cation size. Surprisingly, the highest capacitance was observed in sodium-containing mixtures, suggesting that size and electronegativity are not the sole determinants of capacitive enhancement. The performance of sodium-containing mixtures is additionally beneficial from a technological perspective, as sodium is more abundant than lithium and orthogonal to lithium-ion battery supply chains.

Potassium salt containing mixtures did not exhibit enhanced capacitances at gold electrodes, likely in part due to the increased work function required for potassium to deposit onto gold relative to lithium and sodium. It is possible that with increased cathodic stability, potassium could perform underpotential deposition. This further highlights that arguments derived solely from ion size and electronegativity are not sufficient explanations for the observed trends.

Unlike other metal salts, the addition of magnesium salts to ionic liquids decreased the differential capacitance. Magnesium does not alloy with gold at room temperature, nor does magnesium deposit on gold unless a Grignard reagent is used. Underpotential deposition, or any deposition, of magnesium under the conditions in this Example is highly unlikely. Thus, the capacitive response shown was likely only related to the double layer capacitance.

The overall decrease in interfacial capacitance of magnesium-based salt-in-ionic liquid solutions further exemplifies that packing of smaller, more charge-dense ions was not necessarily a contributor towards increasing capacitance at the electrode-electrolyte interface. Increased ordering due to higher complexation of magnesium ions to TFSI anions may result in the shift in capacitive baseline as opposed to the almost no change in differential capacitance observed in potassium ionic liquid mixtures.

Ternary mixtures of ionic liquids with two different metal cation salts demonstrated enhanced capacitance on gold surfaces when compared to their binary counterparts with equivalent metal ion concentration at negative polarizations. Raman spectroscopy showed that TFSI anions primarily coordinated to the larger metal ion in these solutions. Since the capacitive benefits of metal ions was only seen in the smaller ions tested, lithium and sodium, it is beneficial to have more TFSI anions coordinate to larger metal ions like potassium. Hence, the addition of larger cations to coordinate more TFSI created a solution where the number of alkali ions that could participate in underpotential deposition was increased.

Comparing the properties of ternary mixtures to those of binary lithium solutions shows that coordination was likely the limiting factor in maximizing pseudocapacitance. The binary mixtures showed a capacitive maximum at x=0.1 [Li][TFSI], after which the capacitive gains plateaued and eventually decreased. Since the capacitance of ternary Li/K and Li/Na systems exceeded that of the binary system, the ability for lithium to participate in underpotential deposition may be limited by the ionic network, as opposed to being hindered by surface packing densities.

It has been suggested that there is a change in the nanostructure of the binary mixture once x>0.2 [Li][TFSI]. Similarly, the capacitance of the ternary Na/K mixture exceeded the capacitance magnitude of the binary 10% [Na][TFSI] mixture. This further suggests that underpotential deposition of sodium was hindered by ionic networks in the binary mixtures, in contrast to ternary Na/K. EIS spectra in this Example do not demonstrate strong diffusion limitations. This indicates that the bulk was transporting to and interacting at the surface. The changes in anion coordination observed in the Raman results agreed well with what was presented in the ternary capacitance results.

The modification of the capacitance of potassium, sodium, and ternary Li/K mixtures at positive potentials on gold surfaces suggests that the addition of small metal cations can also impact double layer formation at positive surfaces. This is an example of like-charge co-ion effects in correlated electrolytes, highlighting how double layer formation critically hinges on both counterions and co-ions in correlated electrolytes. In contrast, only counterions play a defining role in classical electrolytes where ion-ion interactions are negligible.

Specifically, the differential capacitance of binary lithium mixtures at positive polarizations decreased with lithium salt concentration. This change was attributed to the formation of negatively charged metal ion complexes. Lithium was thought to coordinate two TFSI anions, forming ([Li][(TFSI)₂])⁻¹ clusters as larger complexes that screened as much charge as singular TFSI anions. This reduced the charge density of bound ion layers, which, in turn, reduced the differential capacitance.

Further, the anodic stability was decreased with addition of sodium and potassium to these mixtures. It has been suggested that these metal ions form complexes with TFSI that have a net negative two charge, ([M][(TFSI)₃])⁻². Such a change was not seen in the magnesium mixtures which were proposed to form complexes also containing four ions, but only had a single net negative charge, ([Mg][(TFSI)₃])⁻¹.

To leverage underpotential deposition in electrochemical capacitors, electrochemical reversibility will be a key consideration. The emergence of a reductive peak was seen in [Li][TFSI]- and [Na][TFSI]-containing mixtures in cyclic voltammetry (CV) conducted under varied scan rates that did not appear in neat [C₄MIm][TFSI] or [K][TFSI]—containing mixtures (data not shown). Capacitive enhancement occurred at potentials consistent with underpotential deposition and above the potential required for deposition by several hundred mV. However, while at a much lower current density, the presence of an oxidative peak in 10% [Li][TFSI] CVs suggests this deposition is reversible. Due to the broadness of the reductive peak in 10% [Na][TFSI] CVs, a distinct oxidative peak was not expected to be seen in this case. Also, comparisons between neat [C₄MIm][TFSI] and a mixture containing x=0.1 [Li][TFSI] were made, cycling the cells for either 10 or 100 cycles. The capacitance of the neat ionic liquid varied slightly with cycle number and decreased by approximately 2 μ Fcm⁻² after 100 cycles. The mixture with [Li][TFSI] showed an earlier capacitive onset after 10 cycles than the initial scan. This could be due to alloying of the gold surface creating more surface sites that lithium can participate in underpotential deposition at less negative polarizations. There was a slight reduction in the capacitance in the [Li][TFSI] containing mixture, much like the neat mixture.

Regardless, significant reversibility was observed that merits serious consideration for integration into device-based experimentation where underpotential deposition is implemented as one-half of an asymmetric electrochemical capacitor. As capacitance was observed to increase substantially at high voltages, the energy density of a device using these electrolytes will scale quadratically with voltage while maximizing capacitance.

The cycling window that was chosen was based upon the maximum capacitance observed in the x=0.05 [Li][TFSI] containing mixtures and the open circuit potential. It was observed that capacitance decreased and became irreversible at higher negative potentials. This could be due to the formation of an SEI on the surface of the Au, as lithium may catalyze SEI formation on Au. This could also explain the increased capacitances observed in mixtures with higher concentrations of lithium.

While observation of this type of irreversible decomposition was expected at voltages higher than the ionic liquid electrochemical window, a significant contribution from pseudocapacitive enhancement prior to decomposition can still be accessed. Thus, the design of ionic liquids with further enhanced cathodic stability, such as for boronium cations, can further bolster underpotential deposition-mediated energy storage.

### CONCLUSIONS

This Example shows that underpotential deposition provides avenues to substantially enhance the interfacial capacitance of salt-in-ionic liquid electrolytes. Importantly, these enhancements occurred under large cathodic biases where ion crowding compromised double layer capacitance in neat ionic liquids. Both sodium and lithium provided underpotential deposition enhancement while potassium neither underwent underpotential deposition nor impacted double layer formation. Interestingly, addition of magnesium modestly lowered double layer capacitance without adding any pseudocapacitive processes. It was found that a complex combination of ion-ion interactions and ion-electrode interactions must be balanced to enable underpotential deposition-enhanced capacitance. Mixtures of two metal salts and an ionic liquid had increased capacitance when compared to their binary counter parts, and Raman spectroscopy showed in ternary mixtures the TFSI anion preferentially coordinated to alkali metal cations with larger radii. As a result, in ternary mixtures of sodium salt, potassium salt, and ionic liquid, the differential capacitance was greater than what was seen in any binary system tested. Additionally, pseudocapacitive processes occurring at cathodic biases were highly reversible, as it was observed that capacitance in lithium containing systems was stable for up to 100 cycles over a 1.5 V window. Ultimately, the results support the use of underpotential deposition as a means of dramatically enhancing the energy density of salt-in-ionic liquid electrolytes to meet rapidly growing needs for leveling power and energy fluctuations in renewable electricity grids.

The word “illustrative” is used herein to mean serving as an example, instance, or illustration. Any aspect or design described herein as “illustrative” is not necessarily to be construed as preferred or advantageous over other aspects or designs. Further, for the purposes of this disclosure and unless otherwise specified, “a” or “an” means “one or more.”

The foregoing description of illustrative embodiments of the disclosure has been presented for purposes of illustration and of description. It is not intended to be exhaustive or to limit the disclosure to the precise form disclosed, and modifications and variations are possible in light of the above teachings or may be acquired from practice of the disclosure. The embodiments were chosen and described in order to explain the principles of the disclosure and as practical applications of the disclosure to enable one skilled in the art to utilize the disclosure in various embodiments and with various modifications as suited to the particular use contemplated. It is intended that the scope of the disclosure be defined by the claims appended hereto and their equivalents.

If not already included, all numeric values of parameters in the present disclosure are proceeded by the term “about” which means approximately. This encompasses those variations inherent to the measurement of the relevant parameter as understood by those of ordinary skill in the art. This also encompasses the exact value of the disclosed numeric value and values that round to the disclosed numeric value.

The term “type” as used herein refers to chemical formula such that a single type means the same chemical formula and different type means different chemical formula.

Terms such as “comprising” and the like may be replaced with terms such as “consisting” and the like.

What is claimed is:

1. A method of amplifying interfacial capacitance in an electrochemical storage device, the method comprising:
applying a voltage to a porous metal electrode of an electrochemical storage device, the electrochemical storage device comprising
the porous metal electrode;
an electrolyte forming an interface with a surface of the porous metal electrode, the electrolyte comprising an ionic liquid and a redox active metal ion; and
a counter electrode in electrical communication with the porous metal electrode,
wherein at the voltage applied, the electrochemical storage device exhibits an increased capacitance as compared to the electrochemical storage device at the voltage applied but absent the redox active metal ion.

2. The method of claim 1, wherein the electrochemical storage device exhibits a capacitance value that is at least 400% of a capacitance value of the electrochemical storage device at the voltage applied but absent the redox active metal ion.

3. The method of claim 1, wherein the voltage applied is less negative than the redox active metal ion's equilibrium potential and the method does not comprise application of a voltage at which the redox active metal ion deposits on itself.

4. The method of claim 1, wherein the redox active metal ion is selected from alkali metal ions.

5. The method of claim 1, wherein the redox active metal ion is selected from alkali metal ions other than Li⁺.

6. The method of claim 1, wherein the redox active metal ion is Na⁺.

7. The method of claim 1, wherein the electrolyte comprises at least two different types of redox active metal ions.

8. The method of claim 7, wherein the at least two different types of redox active metal ions are selected from alkali metals, alkaline earth metals, Zn²⁺, Al³⁺, La³⁺, and Fe³⁺.

9. The method of claim 7, wherein the at least two different types of redox active metal ions comprise K⁺ and at least one of Li⁺ and Na⁺.

10. The method of claim 7, wherein the at least two different redox active metal ions are K⁺ and Na⁺.

11. The method of claim 1, wherein the redox active metal ion is present in the electrolyte at an amount of from 7 mole percent to 13 mole percent.

12. The method of claim 1, wherein the porous metal electrode is gold, copper, silver, or an alloy thereof.

13. The method of claim 1, wherein the ionic liquid is an imidazolium sulfonimide; the redox active metal ions are selected from alkali metals; and the porous metal electrode is gold, copper, silver, or an alloy thereof.

14. The method of claim 13, wherein the redox active metal ions comprise Na⁺.

15. The method of claim 13, wherein the redox active metal ions comprise K⁺ and at least one of Li⁺ and Na⁺.

16. The method of claim 13, wherein the redox active metal ions are present in the electrolyte at a total amount of from 7 mole percent to 13 mole percent.

17. A method of amplifying interfacial capacitance in an electrochemical storage device, the method comprising:
applying a voltage to a porous metal electrode of an electrochemical storage device, the electrochemical storage device comprising
the porous metal electrode;
an electrolyte forming an interface with a surface of the porous metal electrode, the electrolyte comprising an ionic liquid and at least two different types of redox active metal ions; and
a counter electrode in electrical communication with the porous metal electrode,
wherein the voltage applied is less negative than that of each redox active metal ion's equilibrium potential.

18. The method of claim 17, wherein the at least two different types of redox active metal ions are selected from Li⁺, Na⁺, and K⁺.

19. The method of claim 18, wherein the ionic liquid is an imidazolium sulfonimide and the porous metal electrode is gold, copper, silver, or an alloy thereof.

20. An electrochemical storage device comprising:
a porous metal electrode;
an electrolyte forming an interface with a surface of the porous metal electrode, the electrolyte comprising an ionic liquid and a redox active metal ion; and
a counter electrode in electrical communication with the porous metal electrode,
wherein at a voltage applied to the porous metal electrode that is less negative the redox active metal ion's equilibrium potential, the electrochemical storage device exhibits an increased capacitance as compared to the electrochemical storage device at the voltage applied but absent the redox active metal ion.
